(19) United States
(12) Patent Application Publication
(10) Pub. No.: US 2015/0131411 A1
(43) Pub. Date: May 14, 2015

(54) USE OF HYBRID TRANSDUCER ARRAY FOR SECURITY EVENT DETECTION SYSTEM

(71) Applicants: Judson Mannon GUDGEL, Tulsa, OK (US); Johnathan TORKELSON, Tulsa, OK (US); Stewart REED, Tulsa, OK (US); GWACS DEFENSE, INC., Tulsa, OK (US)

(72) Inventors: Judson Mannon Gudgel, Tulsa, OK (US); Jonathan Torkelson, Tulsa, OK (US); Stewart Reed, Spring, TX (US)

(21) Appl. No.: 14/348,717

(22) PCT Filed: Sep. 28, 2012
(86) PCT No.: PCT/US12/57928

§ 371 Date: Mar. 31, 2014

Related U.S. Application Data
(60) Provisional application No. 61/540,948, filed on Sep. 29, 2011.

(51) Int. Cl. G01S 5/22; G01S 5/00

(52) U.S. Cl. CPC G01S 5/22; G01S 5/0036
USPC 367/129

(57) ABSTRACT

Security events, such as gunshots may be determined using hybrid sensors. The hybrid sensors have at least two different elements that are sensitive to the security event, such as conventional microphone and a fiber optic microphone, which, in the case of a gunshot, permits a better scanning of the report of the gunshot to better determine its direction, signature features, and time of arrival. Additionally, sensor can be employed having multiple elements that are sensitive to a security event where at least one of the elements is not coplanar with the rest. This displacement along an orthogonal axis may be used to improve the ability of a network of such sensors to determine the direction and origin of a security event in a three dimensional system.

### BACKGROUND OF THE INVENTION

1. Technical Field

The present invention relates to a security event recognition and location system and a method for using same. The present invention particularly relates to such a system and method having high spatial precision in three dimensions as compared to prior art systems.

2. Background of the Art

Gunshots, and other security issues that have deterministic acoustic signatures, are a part of the combat environment. A combat environment may be a flat open area, but often it is neither flat nor open. For example, combat may occur in hilly or mountainous regions. When a combat area is no longer flat, which is to say, having only two dimensions, X and Y, then the third dimension, Z becomes important. For example, in an urban combat environment such as a city, it is often important to know not just which building houses a sniper, but on which floor of that building the sniper is located.

But even in peace time, an urban area may become subject to security events. For example, a few large cities have become plagued with gunfire. This gunfire may be both related and unrelated to the criminal community. Gunfire does not only occur with crimes. For example, gunfire associated with celebrations in some cities is not a crime, but never the less has been known to cause injury and death. Similarly, gunfire associated with gang activity may be slow to be reported to the authorities resulting in loss of life due to delays in getting medial attention to injured victims.

Some of the cities have adopted location systems that have proven effective in the location of the gunfire. Such systems, sometimes referred to as “gunshot detection systems” are generally known and available. Such systems can be used to detect the source of an acoustic event, the radial direction of an event and/or the general proximity of an event.

While useful in civil situation, such systems have obvious utility in martial situations. Sniper fire, for example, may be more effectively suppressed with better intelligence regarding the location of the sniper. Locating hidden heavy weapons positions may also be useful to soldiers in time of war.

### SUMMARY OF THE INVENTION

In one aspect the invention is a sensor system for determining the direction of an occurrence of a security event from an established reference point comprising: a hybrid set of transducers, a microprocessor, a wireless network via communication module(s); wherein: the transducer elements sensitive to evidence of the event are in communication with the microprocessor allowing the microprocessor to execute and manage event detection functions and algorithms; the wireless network system, via communications module(s), allows for the interfacing and sharing of data between sensors and other components of the system for detecting events; and the system for detecting events functions to resolve the location and time of the event.

Another aspect of the invention is a sensor system for determining the direction of an occurrence of an event from and established reference point comprising: a microprocessor; a wireless network via communication module(s); at least three transducer elements sensitive to evidence of the event wherein at least one element is displaced from the other elements along an orthogonal axis; wherein: the transducer elements sensitive to evidence of the event are in communication with the microprocessor allowing the microprocessor to execute and manage event detection functions and algorithms; the wireless network system allows for the interfacing and sharing of data between sensors and other components of the system for detecting events; and the system for detecting events functions to determine the location and time of the event.

In another aspect, the invention is a method for determining the direction of an occurrence of an event from an established reference point comprising: receiving evidence of the occurrence of an event at level sufficient to be detected by a sensor of the invention wherein the evidence is received by at least two such sensors; using at least the difference of the time of arrival of the evidence at the two sensors, determining the direction relative to an established reference point from which the evidence arrived at the reference point.

In still another aspect, the invention is a method for determining the direction of an occurrence of an event from an established reference point and/or the location of an event comprising: receiving evidence of the occurrence of an event at level sufficient to be detected by a sensor of the invention wherein the evidence is received by at least three of the sensors; and a) using at least the difference in the time of arrival of the evidence at the three sensors, determining the direction relative to an established reference point from which the evidence arrived at the reference point; b) using at least the difference in the time of arrival of the evidence at the three sensors, determining the origin of the event; or both a & b.

### BRIEF DESCRIPTION OF THE DRAWINGS

The invention is further defined by the accompanying drawings, wherein like numerals refer to like parts throughout, and in which:

FIG. 1 is an illustration of a first embodiment of a system of the disclosure comprising two separate arrays of differing types;

FIG. 2 is an illustration of a different embodiment having a single sensor unit made up of a hybrid array of microphones;

FIG. 3 is an illustration of a hybrid microphone array in a 3-dimensional arrangement. Six microphones (3 MEMS+3 electrets);

FIG. 4 is an illustration of an acoustic plane wave approaching a hybrid sensor.

### DETAILED DESCRIPTION OF THE INVENTION

The apparatus of the disclosure is a system and method for the detection and location of a security event. For the purposes of the present application, a security event is an event that can result in the loss of life, the destruction of property, and/or the disruption of commercial activities; and is of interest to police or military organizations. Exemplary security events include, but are not limited to, single gunshots, multiple gunshots, rocket engine ignitions, and small explosions such as occur with the explosion of a mine, hand grenade, or small rocket warhead.

The method of the present invention includes determining a time and a location of a security event. Exemplary prior art includes, for example, that disclosed in U.S. Pat. No. 5,973,998 to Showen, et al., which is fully incorporated herein by reference. Another such system is that of the system disclosed in U.S. Pat. No. 6,847,587 to Patterson, et al., which is fully incorporated herein by reference. Still other systems are disclosed in U.S. Pat. No. 5,703,835 to Sharkey, et al., and U.S. Pat. No. 5,455,868 to Sergent, et al., which are both fully incorporated herein by reference.

The apparatus used to make the hybrid sensors of the disclosure includes elements sensitive to evidence of a security event. Acoustic transducers (microphones) are commonly used for this purpose, such as in the design of gunshot detection systems. However, microphones are often limited by their range and/or response characteristics that directly affect the ability of a gunshot detection system to function in changing environments or in applications with varying acoustic scenarios.

An ideal acoustic transducer would have a large range of sensitivity while also being dynamically capable of capturing rapid sound pressure transitions, and without entering a saturation state or unstable oscillation. The transducer would also be sensitive enough to detect small, or attenuated, features of a security event. Unfortunately, conventional microphone technology does not possess all these qualities in a practical single package. Micro-Electrical-Mechanical System (MEMS) acoustic transducers are known for their miniaturization and ability to respond to high frequency signals. However, they are also known for entering unstable states when the sound pressure level (SPL) is high. Fiber-optic microphones are sometimes referred to as high-fidelity microphones having large dynamic and frequency ranges, but are difficult to implement in a small standalone device. Condenser microphones are well known for their accuracy, stability, and frequency characteristics, but also require involved hardware implementations. Electret microphones, a type of condenser microphone, are known for their simplicity and scale of production, and their ability to ascertain higher sound pressure levels when compared to other miniaturized microphones.

Security events are not all the same and each type of event may span high and low sound pressures as well as a wide frequency bandwidth, and may further be riddled with various types of unpredictable noise. Rather than forcing a single type of element to scan a security event, the apparatus of the embodiments of the disclosure have at least two differing elements.

In one embodiment of an apparatus of the disclosure, a first element sensitive to an event may be a sound transducer array. In this embodiment, there are two or more audio channels. Each audio channel is buffered. Each channel has a different gain setting. The processor monitors the highest sensitivity audio channel for events. In some embodiments, if a channel is over-driven (clipped), software examines the next less sensitive channel including the data that was buffered when the clip occurred. This process can be repeated, stepping to the next less sensitive channel, until a channel is found that hasn't clipped yet which contains the most complete data for pattern and/or other recognition purposes. One advantage of the sound transducer array is that all channels can then be used for calculating time difference of arrival to determine direction and or exact location of the event.

A second element in this embodiment may be any other sound transducer, known or unknown, that is useful for detecting a security event. For example, at least two unlike elements such as a MEMS, fiber optic microphone, or the like, are employed to target portions and/or particular features of a security event. These transducers would be positioned alongside each other thereby virtually coinciding at the same point in an acoustic signal's path. Unlike elements may also be spatially separated per specific detection schema. The dissimilar microphones may be used for discrimination of unwanted signals. Other uses may include mathematical fusing of the hybrid microphone sets to yield a refined result that is not achievable by using only a single type of microphone with post processing techniques.

A security event detection system typically computes solutions for the angle of arrival (AoA) of an unguided munition's shockwave and muzzle blast. AoA, or other sub-computations, are then used to calculate other solutions such as the munition's point of origin or caliber. All this requires an accurate recognition and time measurement of the acoustic signal in a relative space.

One advantage of the apparatus of the disclosure is that they may also be used to determine the angle AoA accurate in all three dimensions. A coplanar array of microphones can provide a decent solution to most scenarios, granted the microphone's polarity is sufficient. In contrast, by constructing an array geometry that is non-coplanar, the ability to measure time difference of arrival between microphones for a wider range of device orientation, or gunshot scenarios is greatly enhanced.

For example, in one embodiment of the method of the disclosure, where a coplanar device is orientated such that the gunshot's shockwave traverses the device's microphone array at a shallow angle (relative to the array's axis) then the time difference measurement would be more susceptible to measurement error. Increasing the microphones' planar spread combats this issue but also increases the footprint of the device. Adding an additional microphone, or microphones, that is non-coplanar will also address this problem and without increasing the device's footprint. The size increase would only increase device size in a different dimension and would provide much more benefit as compared to a similar size change in the coplanar arrangement.

Hybrid microphones built into a 3-dimensional array would provide significant enhancements for all security event detection systems, but especially for the purpose of gunshot detection systems. Practical applications would include the use of various microphone types that have been miniaturized and designed for manufacturability. The alternative would be to use higher end microphones that are more expensive, larger, and have more involved hardware requirements. This is impractical for military applications that require lightweight and low profile solutions.

In addition to the elements already discussed, in some specialized embodiments, other elements may be employed. The element sensitive to the security event may also be an accelerometer, a seismometer, a hydrophone, a radiation detector, a biohazard detector, a gas detector and combinations thereof. The type of element will dictate how it is used. For example, a hydrophone will need to be placed into water while a seismometer will need to be placed in contact with the ground or a fixed support in contact with the ground.

In the practice of the methods of the disclosure, the hybrid sensors may include a communications module. The communications module includes a transmitter/receiver that allows for communications with the wireless network and, in some embodiments, other networks as well. In some embodiments, this communications module may be an ultra-wide band radio module. These modules incorporate ultra-wide band radio technology modules that operate in the in 3.1-10.6 GHz range. In other embodiments, other types of transmitters may be used. Any type of transmitter/receiver known to be useful to those of ordinary skill in the art may be used with the systems of the disclosure. These modules function within the sensors of the invention to: determine the location of each sensor; determine the timing reference for time difference of arrival calculations; and wireless communications of both equipment and operators.

The sensors of the disclosure include a microprocessor. It should be noted that the terms employed in the discussion of the embodiments are to be given their broadest meaning. For example, the term “processor” is intended to be interpreted broadly and to describe programmable and/or reprogrammable devices, including but not limited to microcontrollers, risk processors, ARM processors, digital signal processors, logic arrays, and the like. The processors perform several functions, one of which is recognition of the type of security event that has occurred.

The sensors of the present invention include a wireless network. The wireless network functions to allow the sensors to communicate with each other and, in some embodiments with a central processor as well. In some embodiments, the wireless network is a conventional wireless network and in other embodiments, the wireless network incorporates an ultra-wide band radio module. Any wireless network known to be useful to those of ordinary skill in the art may be used with the systems of the disclosure.

In one embodiment of the invention, at least one of the sensors will include a geolocation module. In another embodiment, all of the sensors will include geolocation modules. One advantage of some embodiments of the disclosure is that the ultra-wide band radio modules allow for a much more precise determination of the location of each sensor relative to every other sensor than is possible by the use of a geolocation system such as a GPS/GNSS device, even systems that incorporate differential correction. The global positioning of a network of the sensors of the present invention is enhanced when the global positioning of each sensor is rationalized against the position of each sensor relative to every other sensor as determined using the ultra-wide band radio modules. In one embodiment of the invention, this would allow for a much more precise location of an event and, when the event is a security event such as a gunshot, a response with precision ordinance or sniper fire.

In one embodiment of the invention, the sensor includes a digital compass to assist with direction finding and other activities. In another embodiment, the sensors include an accelerometer to allow for the processor to ignore or modify results that could be impaired by motion of the sensor.

In one embodiment of the invention, some or even all of the sensors would be portable such that they may be worn by a soldier or law enforcement officer or mounted on a vehicle or a robot such as an ordinance disposal robot or a weapons bearing robot. Other components may also be portable, but of a lesser degree. For example, a larger component may be carried as in the case of a squad leader carrying a central processor for facilitating networking and data sharing. Preferable, all of the equipment necessary for a user to take offensive or defensive actions would be sufficiently portable to be wearable. In such a preferred embodiment, the wearable components would include: a microphone for receiving acoustic events; an amplifier and possibly other signal conditioning circuitry; a processor, typically a digital signal processor, having an analog to digital converter; a geolocation receiver and its associated antenna; and an interface for communicating via a communication network.

In one preferred embodiment of the invention, a sensor may be incorporated into a “wristwatch” like housing which can be worn strapped to the users' wrist and, in an alternative embodiment the sensor may additionally output current time thus serving a dual function. The geolocation and communication antennae may be housed internally or incorporated in a watchband. Additional elements of a wrist worn sensor may include manual controls to allow scrolling through display screens and to allow the mode of operation to be changed; a windscreen or other device to reduce wind noise received by sensor and protect the microphone from weather and from minor impacts. In one preferred embodiment, the sensor has an exterior color which will blend with the soldier's uniform and/or the environment and thus not compromise camouflaging. In still anther alternative embodiment, the wrist worn system would house a host system. In such a configuration, a display could be used to display the location of any soldier in the squad, historical details, receive messages up and down the chain of command, as well as display current shooter information when the squad is fired upon.

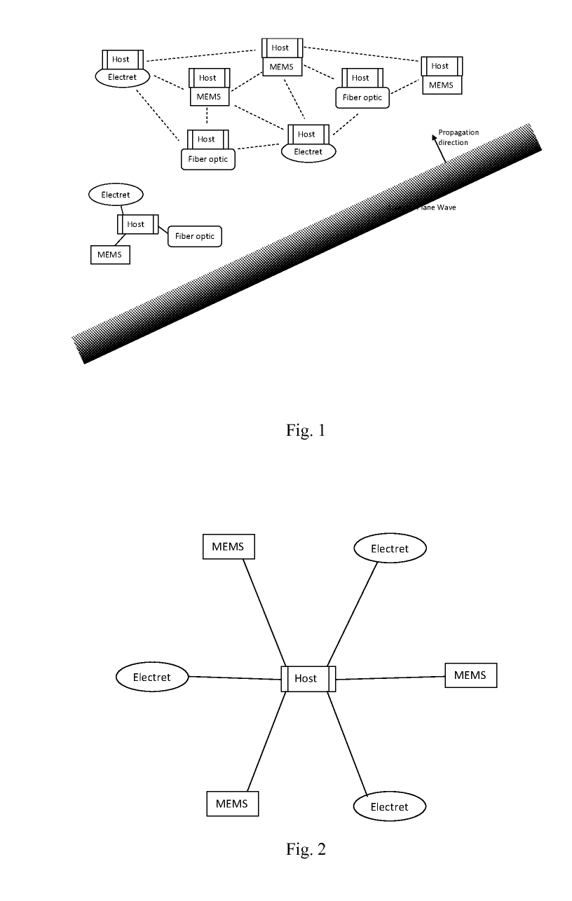

In one embodiment of the invention, a device that may be worn on the wrist and that communicates with each sensor of the invention may be used. This embodiment is illustrated in FIG. 1. Such devices may include: a microprocessor; an active display screen; an array of LED's pointing to the event as illustrated in FIG. 1; a geolocation Module; an Accelerometer; and a magnetometer.

In the practice of the invention, once an event is detected, it may be desirable for a response to the event to occur. When the event is a security event, then that response may include whatever degree of force that is practical in view of the extant circumstance.

In one embodiment of the invention, the sensors of the invention may be used to monitor the location of items, animals or people within a structure. The sensors of the present invention are not dependent upon geolocation devices which may not be functional or sufficiently accurate to, for example, find someone in a structure that is on fire, engulfed with smoke, or collapsed due to flood or earthquake. It follows then that the system of the invention could be very useful in applications including firefighting, other emergency response, finding lost hikers or skiers, finding divers, finding submerged vehicles and the like.

The communication systems useful with the present invention include, but are not limited to: a digital radio link; infrared; wireless Ethernet; Bluetooth; and the like. Preferably, such a link is of minimal power and transmits intermittently to avoid detection by opposing forces.

The sensors of the invention include a power supply, such as a battery. In a preferred embodiment, the power supply is integrated into the sensor.

The sensor of the invention may also include an interface for accessing other systems. In one embodiment, the interface is configured to interface an Ethernet interface.

As stated above, the use of a hybrid sensor, namely one with multiple elements sensitive to the security event are employed, the sensor can do a better job of scanning a the sound of a security event. In some embodiments, such a sensor is a single physical object having at least two and perhaps 5 or even more such elements in a single housing. In other embodiments, the hybrid sensor is a virtual sensor wherein at least some of the physical components are located within separate housings.

The improvement in determining the location of a security event in the Z axis, while preferable determined using a hybrid sensor, may be performed using a non-hybrid sensor as long as there are at least three elements that are sensitive to the security event and at least one of those elements are displaced in the Z axis from the other two.

It should also be noted that while preferred embodiments of the present invention have sometimes been described in connection with gunshot (or other weapon) reports location systems, the techniques for providing a convenient means for equipping a soldier or police officer with a wearable gunshot detection sensor can be applied to other types of systems, such as those monitoring health conditions, environmental conditions, and the like. For example, a patient alarm of a falling patient may be detected in a medical care facility.

Turning now to the drawings, FIG. 1 shows an arrangement of different microphone types for detecting an acoustic plane wave from a gunshot event. The upper array of microphones are encompassed in a multi-sensor network whereas the micro-array shown in the lower left is a single sensor unit made up of three different microphone types: electrets, MEMS, and fiber optic.

FIG. 2 shows a single sensor unit made up of a hybrid array of microphones. Two microphone types shown: MEMS and electrets. Microphones may be positioned in different geometries. For this embodiment the microphones are all placed on the same plane and alternated in a circular pattern.

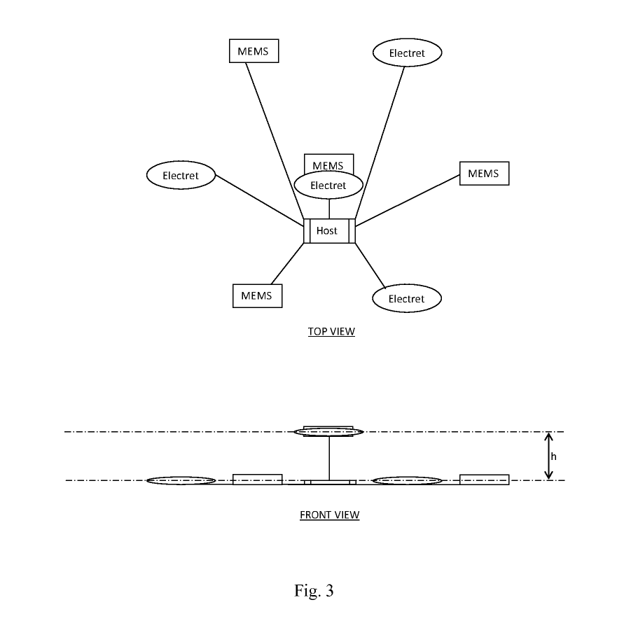

FIG. 3 shows a hybrid microphone array in a 3-dimensional arrangement. Six microphones (3 MEMS+3 electrets) are positioned in a circular coplanar orientation wherein two additional microphones (1 MEMS+1 electret) are placed central to the other microphones and raised a distance ‘h’ above the coplanar microphones. This embodiment illustrates a 3-dimensional arrangement of microphones that enhances ability to detect acoustic waves that transverses the hybrid microphone array at an off-angle.

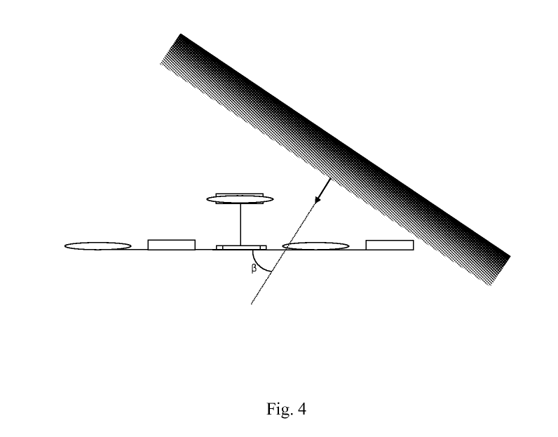

FIG. 4 illustrates an off-angle propagation direction of an acoustic wave relative to the coplanar microphones. The basic reasoning behind using a 3-dimensional orientation is to improve time difference of arrival (TDOA) measurements between microphones. Coplanar microphones will have reducing TDOA values as the acoustic wave's propagation angle nears a perpendicular direction. An off-plane microphone would alternatively have an increasing TDOA. Three-dimensional arrays become even more important as the acoustic wave may be a non-planar form, such as a parabola.

The following example is provided to more fully illustrate the invention. As such, it is intended to be merely illustrative and should not be construed as being limitative of the scope of the invention in any way. Those skilled in the art will appreciate that modifications may be made to the invention as described without altering its scope.

### EXAMPLES

### Hypothetical Example 1

A sniper fires at a member of a squad of soldiers. At least two of the soldiers in the squad are wearing hybrid sensors of the invention. The report from the snipers weapon is received at the two sensors, the audio signal is conditioned and digitized and processed to detect the gunshot. Upon detecting a gunshot, a time of arrival and sensor position are obtained from a GPS receiver and transmitted to a host system. The direction of the sniper at the time of the attack is transmitted to the squad whereupon some members take cover and other members take actions to neutralize the sniper.

### Hypothetical Example 2

Example 1 is repeated but this time there are at least three sensors present and the location of the sniper is trilateralized. Precision return fire is performed using a mobile gun platform robot have mounted thereon a sniper rifle.

### Hypothetical Example 3

Example 2 is repeated except that this time, one of the hybrid sensors includes at least one sound transducer that is displaced from the other elements that are sensitive the sound of the gunshot. Using the displacement, the location of the security is trilateralized in three dimensions. The location is determined to be a building on the 14^{th} floor. Precision return fire is performed using a mobile gun platform robot have mounted thereon a sniper rifle.

What is claimed is:

1. A sensor system for determining the direction of an occurrence of a security event from an established reference point comprising: a hybrid set of transducers, a microprocessor, and a wireless network via communication module(s);
wherein: the transducer elements sensitive to evidence of the event are in communication with the microprocessor allowing the microprocessor to execute and manage event detection functions and algorithms; the wireless network system, via communications module(s), allows for the interfacing and sharing of data between sensors and other components of the system for detecting events; and the system for detecting events functions to resolve the location and time of the event.

2. The system of claim 1 wherein the security events may be selected from the group consisting of single gunshots, multiple gunshots, rocket engine ignitions, and small explosions.

3. The system of claim 2 wherein the small explosion is such as would occur with the explosion of a mine, hand grenade, or small rocket warhead.

4. The system of claim 1 wherein the hybrid set of transducers is prepared using at least two elements sensitive to evidence of a security event.

5. The system of claim 4 wherein the elements sensitive to evidence of a security event are selected from the group consisting of acoustic transducers, Micro-Electrical-Mechanical System acoustic transducers; Fiber-optic microphones; Condenser microphones; and Electret microphones.

6. The system of claim 5 wherein the hybrid set of transducers have buffered audio channels.

7. The system of claim 5 wherein a gain on each of the at least two elements may be set independently of each other.

8. The system of claim 1 wherein the angle of arrival of evidence of a security event may be determined in all three dimensions.

9. The system of claim 1 wherein the system may further include an accelerometer, photometer, a seismometer, a hydrophone, a radiation detector, a biohazard detector, a gas detector and combinations thereof.

10. The system of claim 1 wherein the processor is a programmable and/or reprogrammable device.

11. The system of claim 10 the programmable and/or reprogrammable device is selected from the group consisting of microcontrollers, risk processors, ARM processors, digital signal processors, logic arrays, and combinations thereof.

11. The system of claim 1 wherein the wireless network comprises an ultra-wide band radio module.

12. The system of claim 1 wherein the system includes a geolocation module such as a GPS or GNSS device.

13. The system of claim 1 wherein the system includes a digital compass.

14. The system of claim 1 further comprising a platform upon which it is installed.

15. The system of claim 14 wherein the platform is mobile.

16. The system of claim 15 wherein the platform which is mobile is selected from the group consisting of a soldier, a law enforcement officer, a vehicle, an ordinance disposal robot, and a weapons bearing robot.

17. The System of claim 1 further comprising a battery.

18. A sensor system for determining the direction of an occurrence of an event from and established reference point comprising: a microprocessor; a wireless network via communication module(s); and at least three transducer elements sensitive to evidence of the event wherein at least one element is displaced from the other elements along an orthogonal axis;
wherein: the transducer elements sensitive to evidence of the event are in communication with the microprocessor allowing the microprocessor to execute and manage event detection functions and algorithms; the wireless network system allows for the interfacing and sharing of data between sensors and other components of the system for detecting events; and the system for detecting events functions to determine the location and time of the event.

19. A method for determining the direction of an occurrence of an event from an established reference point comprising:
receiving evidence of the occurrence of an event at level sufficient to be detected by a sensor of the invention wherein the evidence is received by at least two such sensors; and
using at least the difference of the time of arrival of the evidence at the two sensors, determining the direction relative to an established reference point from which the evidence arrived at the reference point.

20. A method for determining the direction of an occurrence of an event from an established reference point and/or the location of an event comprising:
receiving evidence of the occurrence of an event at level sufficient to be detected by a sensor of the invention wherein the evidence is received by at least three of the sensors; and
a) using at least the difference in the time of arrival of the evidence at the three sensors, determining the direction relative to an established reference point from which the evidence arrived at the reference point;
b) using at least the difference in the time of arrival of the evidence at the three sensors, determining the origin of the event;
or both a & b.
